(19) United States
(12) Patent Application Publication
(10) Pub. No.: US 2022/0201789 A1
(43) Pub. Date: Jun. 23, 2022

(54) Redirection Method And Related Device

(71) Applicant: HUAWEI TECHNOLOGIES CO., LTD., Shenzhen (CN)

(72) Inventors: Maorong YE, Shanghai (CN); Baokun SHAN, Shenzhen (CN)

(21) Appl. No.: 17/692,304

(22) Filed: Mar. 11, 2022

Related U.S. Application Data
(63) Continuation of application No. PCT/CN2019/105795, filed on Sep. 12, 2019.

(51) Int. Cl. H04W 76/18; H04W 48/20; H04W 76/19

(52) U.S. Cl. CPC H04W 76/18; H04W 76/19; H04W 48/20

(57) ABSTRACT

The present disclosure relates to redirection methods and devices. In one example method, a terminal device sends a radio resource control (RRC) connection request message to a network device, where the RRC connection request message is used to request to establish an RRC connection in a first cell. The terminal device receives an RRC connection reject message sent by the network device, where the RRC connection reject message includes redirection information. The terminal device chooses, based on the redirection information, to camp on a second cell.

### CROSS-REFERENCE TO RELATED APPLICATIONS

This application is a continuation of International Application No. PCT/CN2019/105795, filed on Sep. 12, 2019, which is hereby incorporated by reference in its entirety.

### TECHNICAL FIELD

This application relates to the field of wireless network technologies, and in particular, to a redirection method and a related device.

### BACKGROUND

A cellular-based narrowband internet of things (narrow band internet of things, NB-IoT) becomes an important branch of an internet of everything network. The NB-IoT is constructed from a cellular network and consumes bandwidth of only approximately 180 kHz. The NB-IoT is an emerging technology in the IoT field, supports a cellular data connection of a low-power device in a wide area network, and is also referred to as a low-power wide area network (low-power wide-area network, LPWA). The NB-IoT supports an efficient connection of a device with long standby time and a relatively high requirement for a network connection. In the NB-IoT network, redirection is a technology of directing a service of a terminal device (user equipment, UE) from a current cell to another different carrier cell based on redirection information carried in a radio resource control (radio resource control, RRC) release message. However, because a service characteristic of the NB-IoT determines that a time interval between two services of the NB-IoT may be an hour level or even longer, load sharing is not timely. In addition, in a congestion scenario, because the UE may not be able to perform access, load sharing cannot be triggered, and consequently, congestion is aggravated.

### SUMMARY

This application provides a redirection method and a related device, to implement redirection in an access process, and implement timely network load sharing and network load balancing.

According to a first aspect, an embodiment of this application provides a redirection method, including: A terminal device sends a radio resource control RRC connection request message to a network device, where the RRC connection request message is used to request to establish an RRC connection in a first cell; receives an RRC connection reject message sent by the network device, where the RRC connection reject message carries redirection information; and chooses, based on the redirection information, to camp on a second cell. The redirection information is added to the RRC connection reject message, so that redirection may be triggered in an access process of the terminal device, and therefore, load is shared in a timely manner. In a case of network congestion, the terminal device is redirected to a cell with relatively light load, to implement network load balancing. In this way, redirection is more flexible and efficient.

In a possible design, the redirection information includes a plurality of carrier frequencies, and the terminal device searches the plurality of carrier frequencies, and chooses to camp on a second cell corresponding to a target carrier frequency in the plurality of carrier frequencies.

In another possible design, the terminal device obtains reference signal received power RSRP corresponding to each of the plurality of carrier frequencies, and chooses, based on the RSRP, to camp on the second cell corresponding to the target carrier frequency in the plurality of carrier frequencies. This can ensure that RSRP of the cell chosen to camp on meets a requirement.

In another possible design, the redirection information includes a redirection carrier dedicated offset, and the redirection carrier dedicated offset is added to RSRP of one of the plurality of carrier frequencies to reduce a probability that a cell corresponding to the carrier frequency is chosen. In this way, repeated attempts to access are reduced, and access efficiency is improved.

In another possible design, the redirection information includes extended waiting time, and the extended waiting time indicates waiting duration in which the terminal device searches the first cell again to establish an RRC connection. In this way, a quantity of times of repeated attempts to access is reduced, and network load is reduced.

According to a second aspect, an embodiment of this application provides a redirection method, including: A network device receives a radio resource control RRC connection request message sent by a terminal device, where the RRC connection request message is used to request to establish an RRC connection in a first cell; and sends an RRC connection reject message to the terminal device, where the RRC connection reject message carries redirection information, and the redirection information indicates the terminal device to choose to camp on a second cell. The redirection information is added to the RRC connection reject message, so that redirection may be triggered in an access process of the terminal device, and therefore, load is shared in a timely manner. In a case of network congestion, the terminal device is redirected to a cell with relatively light load, to implement network load balancing. In this way, redirection is more flexible and efficient.

In a possible design, the redirection information includes a plurality of carrier frequencies, and the plurality of carrier frequencies are used by the terminal device to perform searching and choose to camp on a second cell corresponding to a target carrier frequency.

In another possible design, the redirection information includes a redirection carrier dedicated offset, and the redirection carrier dedicated offset is added to RSRP of one of the plurality of carrier frequencies to reduce a probability that a cell corresponding to the carrier frequency is chosen. In this way, repeated attempts to access are reduced, and access efficiency is improved.

In another possible design, the redirection information includes extended waiting time, and the extended waiting time indicates waiting duration in which the terminal device searches the first cell again to establish an RRC connection. In this way, a quantity of times of repeated attempts to access is reduced, and network load is reduced.

In another possible design, when load of the first cell exceeds a first preset threshold or load of a core network in which the first cell is located exceeds a second preset threshold, the network device sends the RRC connection reject message to the terminal device.

According to a third aspect, an embodiment of this application provides a first redirection apparatus. The first redirection apparatus is configured to implement the method and the function performed by the terminal device in the foregoing first aspect, and is implemented by hardware/software, and the hardware/software includes a module corresponding to the foregoing function.

According to a fourth aspect, an embodiment of this application provides a second redirection apparatus. The second redirection apparatus is configured to implement the method and the function performed by the network device in the foregoing second aspect, and is implemented by hardware/software, and the hardware/software includes a module corresponding to the foregoing function.

According to a fifth aspect, an embodiment of this application provides a terminal device, including a processor, a memory, and a communication bus. The communication bus is configured to implement connection and communication between the processor and the memory, and the processor executes a program stored in the memory, to implement the steps in the first aspect.

In a possible design, the terminal device provided in this application may include a corresponding module configured to perform behavior of the network device in the foregoing method design. The module may be software and/or hardware.

According to a sixth aspect, an embodiment of this application provides a network device, including a processor, a memory, and a communication bus. The communication bus is configured to implement connection and communication between the processor and the memory, and the processor executes a program stored in the memory, to implement the steps provided in the second aspect.

In a possible design, the network device provided in this application may include a corresponding module configured to perform behavior of the terminal device in the foregoing method design. The module may be software and/or hardware.

According to a seventh aspect, this application provides a computer-readable storage medium. The computer-readable storage medium stores instructions, and when the instructions are run on a computer, the computer is enabled to perform the method according to the foregoing aspects.

According to an eighth aspect, this application provides a computer program product including instructions. When the computer program product runs on a computer, the computer is enabled to perform the method according to the foregoing aspects.

According to a ninth aspect, a chip is provided, and includes a processor. The chip is configured to invoke instructions from a memory and run the instructions stored in the memory, so that a communication device in which the chip is installed performs the method in any one of the foregoing aspects.

According to a tenth aspect, an embodiment of this application further provides another chip. The chip may be a chip in a network device or a terminal device. The chip includes an input interface, an output interface, and a processing circuit. The input interface, the output interface, and the processing circuit are connected to each other by using an internal connection path, and the processing circuit is configured to perform the method in any one of the foregoing aspects.

According to an eleventh aspect, another chip is provided, and includes an input interface, an output interface, and a processor. Optionally, the chip further includes a memory. The input interface, the output interface, the processor, and the memory are connected through an internal connection path. The processor is configured to execute code in the memory. When the code is executed, the processor is configured to perform the method in any one of the foregoing aspects.

According to a twelfth aspect, an apparatus is provided, and is configured to implement the method according to any one of the foregoing aspects.

### BRIEF DESCRIPTION OF DRAWINGS

To describe the technical solutions in the embodiments of this application or in the background more clearly, the following describes the accompanying drawings for describing the embodiments of this application or the background.

FIG. 1 is a schematic diagram of a structure of a communication system according to an embodiment of this application;

FIG. 2 is a schematic flowchart of a redirection method according to an embodiment of this application;

FIG. 3 is a schematic flowchart of another redirection method according to an embodiment of this application;

FIG. 4 is a schematic diagram of a structure of a first redirection apparatus according to an embodiment of this application;

FIG. 5 is a schematic diagram of a structure of a second redirection apparatus according to an embodiment of this application;

FIG. 6 is a schematic diagram of a structure of a terminal device according to an embodiment of this application; and

FIG. 7 is a schematic diagram of a structure of a network device according to an embodiment of this application.

### DESCRIPTION OF EMBODIMENTS

The following describes the embodiments of this application with reference to the accompanying drawings in the embodiments of this application.

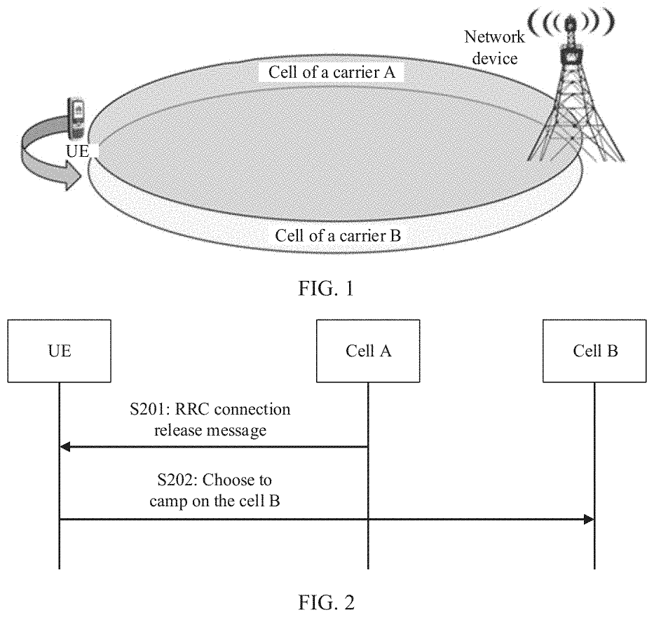

FIG. 1 is a schematic diagram of a structure of a communication system according to an embodiment of this application. The communication system may include a network device and a terminal device. The communication system may be located in an NB-IoT network, for example, an inter-frequency co-coverage networking (in other words, a same area covers different carrier frequencies) scenario. As shown in FIG. 1, UE is located in both a cell of a carrier A and a cell of a carrier B. The two cells may belong to a same network device or different network devices. It should be understood that the communication system to which the method in the embodiments of this application is applicable may include more or fewer network devices or terminal devices. The network device or the terminal device may be hardware, may be software obtained through functional division, or may be a combination thereof. The network device and the terminal device may communicate with each other via another device or network element. The network device may be a base station, an access point, a relay node, a base transceiver station (base transceiver station, BTS), a NodeB (NodeB, NB), an evolved NodeB (evolved NodeB, eNB), or a 5G base station, and is a device that is in an access network and that communicates with a wireless terminal on an air interface by using one or more sectors. By converting a received air interface frame into an IP packet, the network device may be used as a router between the terminal device and another part of the access network, and the access network may include an internet protocol network. The network device may further coordinate attribute management of the air interface. The terminal device may be a cellular phone, a smartphone, a portable computer, a handheld communication device, a handheld computing device, a satellite radio apparatus, a global positioning system, a personal digital assistant (personal digital assistant, PDA), and/or any other suitable device configured to perform communication in a wireless communication system. In the communication system, a public land mobile network (public land mobile network, PLMN), a device-to-device (device-to-device, D2D) network, a machine to machine (machine to machine, M2M) network, an internet of things (internet of things, IoT), or another network may be used. The method according to the embodiments of this application may be applied to the communication system shown in FIG. 1.

FIG. 2 is a schematic flowchart of a redirection method according to an embodiment of this application. Details are as follows:

S201: UE establishes an RRC connection in a cell A and performs service processing. After service processing is completed, the cell A triggers a redirection procedure, an eNB sends an RRC release (release) message to the UE, and the UE receives the RRC release message sent by the eNB. The RRC release message carries redirection information, and the redirection information includes a carrier frequency.

S202: The UE chooses, based on the redirection information, to camp on a cell B corresponding to the carrier frequency.

However, the foregoing technical solutions have the following disadvantages: First, a service frequency of a mainstream service model of an NB-IoT is relatively low, and a time interval between two services is usually at a level of several hours or even one day. Redirection occurs in a release procedure after a service of the UE is completed, and load can be shared only in a next service of the UE, and a load sharing delay is large. Second, in an inter-frequency co-coverage scenario, if congestion occurs in the cell A, an RRC connection of the UE may fail to be established or may be rejected, and the RRC connection cannot be established. In this case, an RRC release procedure does not exist, and therefore redirection cannot be triggered. However, because access of the UE fails, the UE continuously initiates an access attempt. Consequently, continuous congestion is aggravated. To resolve the foregoing technical problems, the embodiments of this application provide the following solutions.

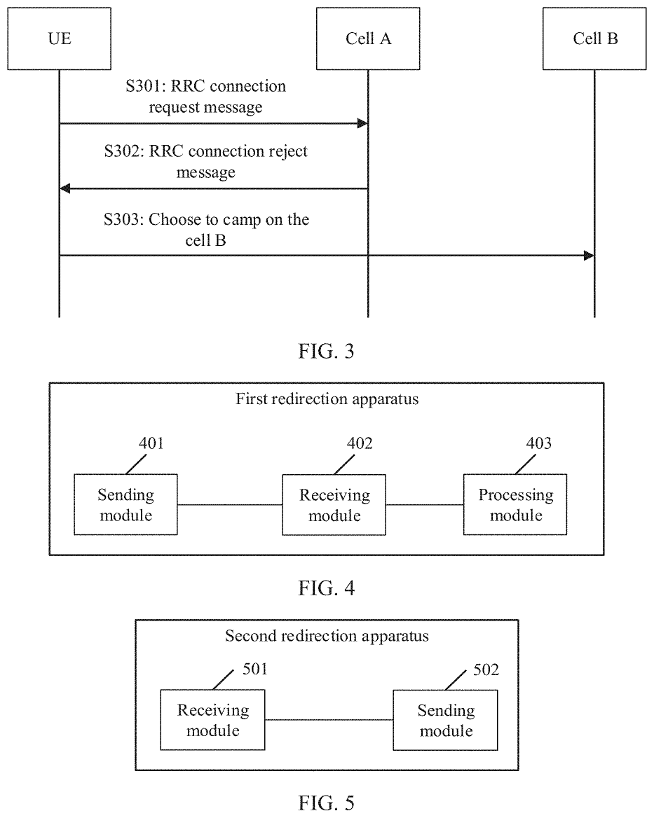

FIG. 3 is a schematic flowchart of a redirection method according to an embodiment of this application. The method includes but is not limited to the following steps.

S301: A terminal device sends a radio resource control RRC connection request message (RRC connection request) to a network device, and the network device receives the RRC connection request message sent by the terminal device, where the RRC connection request message is used to request to establish an RRC connection in a first cell.

Optionally, after the terminal device sends the RRC connection request message, if the first cell allows the terminal device to access, the network device may send an RRC connection success message to the terminal device, to indicate that an RRC connection between the terminal device and the network device is successfully established and data may be transmitted based on the established RRC connection.

S302: The network device sends an RRC connection reject message (RRC connection reject) to the terminal device, and the terminal device receives the RRC connection reject message sent by the network device, where the RRC connection reject message carries redirection information (redirected carrier info).

In specific implementation, when load of the first cell exceeds a first preset threshold or load of a core network in which the first cell is located exceeds a second preset threshold, the network device sends the RRC connection reject message to the terminal device. Alternatively, when load of the first cell exceeds a first preset threshold or load of a core network in which the first cell is located exceeds a second preset threshold, the network device sends the RRC connection reject message to the terminal device.

The redirection information may include a plurality of carrier frequencies, or may include a carrier frequency of a target cell. The redirection information may include a redirection carrier dedicated offset (redirected carrier offset dedicated), and the redirection carrier dedicated offset is added to reference signal received power (reference signal receiving power, RSRP) of one of the plurality of carrier frequencies to reduce a probability that a cell corresponding to the carrier frequency is chosen. The redirection information includes extended waiting time (extended wait time), and the extended waiting time indicates waiting duration in which the terminal device searches the first cell again to establish an RRC connection. The redirection information may further include other information, including but not limited to the foregoing several types of information.

S303: The terminal device chooses, based on the redirection information, to camp on a second cell.

In specific implementation, the redirection information may include a plurality of carrier frequencies, and the terminal device may search a plurality of cells based on the plurality of carrier frequencies, and choose to camp on a second cell corresponding to a target carrier frequency in the plurality of carrier frequencies. Further, the terminal device may obtain reference signal received power RSRP corresponding to each of the plurality of carrier frequencies, and choose, based on the RSRP, to camp on the second cell corresponding to the target carrier frequency in the plurality of carrier frequencies. For example, a cell corresponding to largest RSRP may be chosen for camping. After the carrier frequency of the second cell is chosen, the RRC connection request message may be sent to a network device in which the second cell is located.

Optionally, if the terminal device finds no appropriate cell to camp on after searching one or more carrier frequencies, the terminal device may choose to camp on any cell.

Optionally, if duration in which the terminal device searches a cell based on one of the carrier frequencies exceeds preset duration, searching in the cell is stopped, and the terminal device may choose a next carrier frequency and search another cell to camp on, or if duration of searching for a cell based on the plurality of carrier frequencies exceeds preset duration, the terminal device may re-choose to camp on the first cell. The preset duration may be maximum time allowed by the network device for searching. In addition, after the terminal device sends the RRC connection request message to a specific cell for a first time, the extended waiting time is required before the terminal device can send the RRC connection request message to the cell for a second time.

It should be noted that when searching the plurality of carrier frequencies, if the terminal device does not find a cell based on one of the carrier frequencies or a found cell does not meet a camping requirement (for example, RSRP is relatively small), the terminal device may add a redirection carrier dedicated offset to RSRP corresponding to the carrier frequency, to improve difficulty of choosing the carrier frequency. A larger redirection carrier dedicated offset leads to a smaller probability that a cell corresponding to the carrier frequency is chosen. The terminal device may start to search a next cell until an appropriate cell to camp on is found.

In this embodiment of this application, the redirection information is added to the RRC connection reject message, so that redirection may be triggered in an access process of the terminal device, and therefore, load is shared in a timely manner. In a case of network congestion, the terminal device is redirected to a cell with relatively light load, to implement network load balancing. In this way, redirection is more flexible and efficient.

The foregoing describes in detail the method in the embodiments of this application. The following provides apparatuses in the embodiments of this application.

FIG. 4 is a schematic diagram of a structure of a first redirection apparatus according to an embodiment of this application. The first redirection apparatus may include a sending module 401, a receiving module 402, and a processing module 403. Detailed descriptions of the units are as follows:

The sending module 401 is configured to send a radio resource control RRC connection request message to a network device, where the RRC connection request message is used to request to establish an RRC connection in a first cell.

The receiving module 402 is configured to receive an RRC connection reject message sent by the network device, where the RRC connection reject message carries redirection information.

The processing module 403 is configured to choose, based on the redirection information, to camp on a second cell.

Optionally, the redirection information includes a plurality of carrier frequencies, and the processing module 403 is configured to: search the plurality of carrier frequencies, and choose to camp on a second cell corresponding to a target carrier frequency in the plurality of carrier frequencies.

Optionally, the processing module 403 is further configured to: obtain reference signal received power RSRP corresponding to each of the plurality of carrier frequencies, and choose, based on the RSRP, to camp on the second cell corresponding to the target carrier frequency in the plurality of carrier frequencies.

The redirection information includes a redirection carrier dedicated offset, and the redirection carrier dedicated offset is added to RSRP of one of the plurality of carrier frequencies to reduce a probability that a cell corresponding to the carrier frequency is chosen.

The redirection information includes extended waiting time, and the extended waiting time indicates waiting duration in which the terminal device searches the first cell again to establish an RRC connection.

It should be noted that, for implementation of each module, refer to the corresponding description in the method embodiment shown in FIG. 3, to perform the method and the function performed by the terminal device in the foregoing embodiment.

FIG. 5 is a schematic diagram of a structure of a second redirection apparatus according to an embodiment of this application. The first redirection apparatus may include a receiving module 501 and a processing module 502. Detailed descriptions of the units are as follows:

The receiving module 501 is configured to receive a radio resource control RRC connection request message sent by a terminal device, where the RRC connection request message is used to request to establish an RRC connection in a first cell.

The sending module 502 is configured to send an RRC connection reject message to the terminal device, where the RRC connection reject message carries redirection information, and the redirection information indicates the terminal device to choose to camp on a second cell.

The redirection information includes a plurality of carrier frequencies, and the plurality of carrier frequencies are used by the terminal device to perform searching and choose to camp on a second cell corresponding to a target carrier frequency.

The redirection information includes a redirection carrier dedicated offset, and the redirection carrier dedicated offset is added to RSRP of one of the plurality of carrier frequencies to reduce a probability that a cell corresponding to the carrier frequency is chosen.

The redirection information includes extended waiting time, and the extended waiting time indicates waiting duration in which the terminal device searches the first cell again to establish an RRC connection.

Optionally, the sending module 502 is further configured to: when load of the first cell exceeds a first preset threshold or load of a core network in which the first cell is located exceeds a second preset threshold, send the RRC connection reject message to the terminal device.

It should be noted that, for implementation of each module, refer to the corresponding description in the method embodiment shown in FIG. 3, to perform the method and the function performed by the network device in the foregoing embodiment.

FIG. 6 is a schematic diagram of a structure of a terminal device according to an embodiment of this application. As shown in FIG. 6, the terminal device may include at least one processor 601, at least one communication interface 602, at least one memory 603, and at least one communication bus 604.

The processor 601 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content disclosed in this application. Alternatively, the processor may be a combination for implementing a computing function, for example, a combination including one or more microprocessors, or a combination of a digital signal processor and a microprocessor. The communication bus 604 may be a peripheral component interconnect PCI bus, an extended industry standard architecture EISA bus, or the like. The bus may be classified into an address bus, a data bus, a control bus, or the like. For ease of representation, only one thick line is used to represent the bus in FIG. 6, but this does not mean that there is only one bus or only one type of bus. The communication bus 604 is configured to implement connection and communication between these components. The communication interface 602 of the device in this embodiment of this application is configured to perform signaling or data communication with another node device. The memory 603 may include a volatile memory, for example, a nonvolatile dynamic random access memory (nonvolatile random access memory, NVRAM), a phase-change random access memory (phase-change RAM, PRAM), or a magnetoresistive random access memory (magnetoresistive RAM, MRAM). The memory may further include a nonvolatile memory, for example, at least one magnetic disk storage device, an electrically erasable programmable read-only memory (electrically erasable programmable read-only memory, EEPROM), a flash storage device such as a NOR flash memory (NOR flash memory) or a NAND flash memory (NAND flash memory), or a semiconductor device such as a solid-state drive (solid-state drive, SSD). Optionally, the memory 603 may be at least one storage apparatus that is located away from the foregoing processor 601. Optionally, the memory 603 may further store a group of program code, and the processor 601 may optionally further execute a program executed in the memory 603.

A radio resource control RRC connection request message is sent to a network device, where the RRC connection request message is used to request to establish an RRC connection in a first cell.

An RRC connection reject message sent by the network device is received, where the RRC connection reject message carries redirection information.

A second cell is chosen based on the redirection information to camp on.

The processor 601 is further configured to perform the following operation: searching the plurality of carrier frequencies, and choosing to camp on a second cell corresponding to a target carrier frequency in the plurality of carrier frequencies.

The processor 601 is further configured to perform the following operations:

obtaining reference signal received power RSRP corresponding to each of the plurality of carrier frequencies; and

choosing, based on the RSRP, to camp on the second cell corresponding to the target carrier frequency in the plurality of carrier frequencies.

The redirection information includes a redirection carrier dedicated offset, and the redirection carrier dedicated offset is added to RSRP of one of the plurality of carrier frequencies to reduce a probability that a cell corresponding to the carrier frequency is chosen.

The redirection information includes extended waiting time, and the extended waiting time indicates waiting duration in which the terminal device searches the first cell again to establish an RRC connection.

Further, the processor may further cooperate with the memory and the communication interface to perform operations performed by the terminal device in the foregoing embodiments of this application.

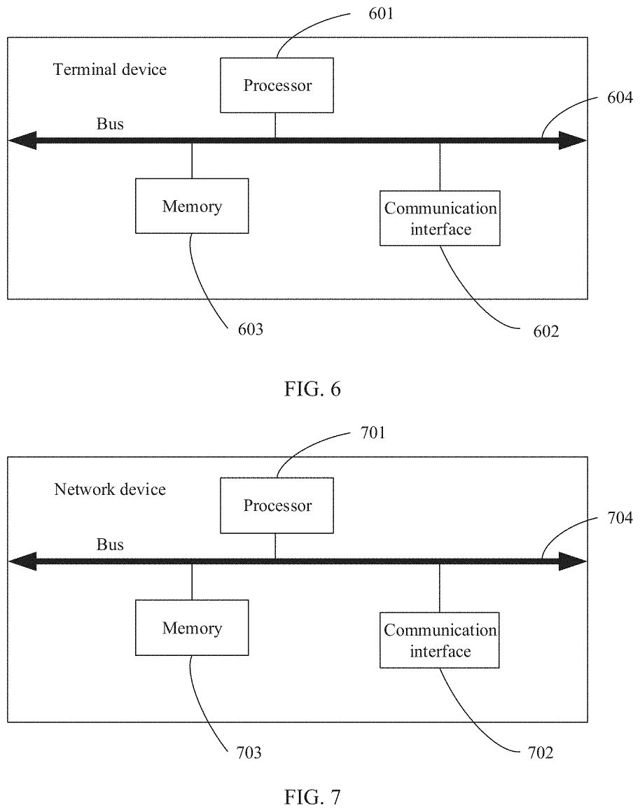

FIG. 7 is a schematic diagram of a structure of a network device according to an embodiment of this application. As shown in the figure, the network device may include at least one processor 701, at least one communication interface 702, at least one memory 703, and at least one communication bus 704.

The processor 701 may be the various types of processors described above. The communication bus 704 may be a peripheral component interconnect PCI bus, an extended industry standard architecture EISA bus, or the like. The bus may be classified into an address bus, a data bus, a control bus, or the like. For ease of representation, only one thick line is used to represent the bus in FIG. 7, but this does not mean that there is only one bus or only one type of bus. The communication bus 704 is configured to implement connection and communication between these components. The communication interface 702 of the device in this embodiment of this application is configured to perform signaling or data communication with another node device. The memory 703 may be the various types of memories described above. Optionally, the memory 703 may be at least one storage apparatus that is away from the processor 701. The memory 703 stores a group of program code, and the processor 701 executes a program that is in the memory 703 and that is executed by the foregoing network device.

A radio resource control RRC connection request message sent by a terminal device is received, where the RRC connection request message is used to request to establish an RRC connection in a first cell.

An RRC connection reject message is sent to the terminal device, where the RRC connection reject message carries redirection information, and the redirection information indicates the terminal device to choose to camp on a second cell.

The redirection information includes a plurality of carrier frequencies, and the plurality of carrier frequencies are used by the terminal device to perform searching and choose to camp on a second cell corresponding to a target carrier frequency.

The redirection information includes a redirection carrier dedicated offset, and the redirection carrier dedicated offset is added to RSRP of one of the plurality of carrier frequencies to reduce a probability that a cell corresponding to the carrier frequency is chosen.

The redirection information includes extended waiting time, and the extended waiting time indicates waiting duration in which the terminal device searches the first cell again to establish an RRC connection.

The processor 601 is further configured to perform the following operation:

when load of the first cell exceeds a first preset threshold or load of a core network in which the first cell is located exceeds a second preset threshold, sending the RRC connection reject message to the terminal device.

Further, the processor may further cooperate with the memory and the communication interface to perform operations performed by the network device in the foregoing embodiments of this application.

An embodiment of this application further provides a chip system. The chip system includes a processor, configured to support a network device or a terminal device in implementing the functions involved in any one of the foregoing embodiments, for example, generating or processing data and/or information involved in the foregoing methods. In a possible design, the chip system may further include a memory, and the memory is configured to store program instructions and data that are necessary for the network device or the terminal device. The chip system may include a chip, or may include a chip and another discrete component.

An embodiment of this application further provides a processor, configured to be coupled to a memory, and configured to perform any method and function related to a network device or a terminal device in any one of the foregoing embodiments.

An embodiment of this application further provides a computer program product that includes instructions. When the computer program product is run on a computer, the computer is enabled to perform any method and function related to a network device or a terminal device in any one of the foregoing embodiments.

An embodiment of this application further provides an apparatus, configured to perform any method and function related to a network device or a terminal device in any one of the foregoing embodiments.

An embodiment of this application further provides a wireless communication system, and the system includes at least one network device and at least one terminal device that are involved in any one of the foregoing embodiments.

All or some of the foregoing embodiments may be implemented by using software, hardware, firmware, or any combination thereof. When software is used for implementation, all or some of the embodiments may be implemented in a form of a computer program product. The computer program product includes one or more computer instructions. When the computer program instructions are loaded and executed on a computer, the procedure or functions according to the embodiments of this application are all or partially generated. The computer may be a general-purpose computer, a dedicated computer, a computer network, or another programmable apparatus. The computer instructions may be stored in a computer readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state drive, SSD)), or the like.

The objectives, technical solutions, and beneficial effects of this application are further described in detail in the foregoing specific implementations. Any modification, equivalent replacement, or improvement made without departing from the spirit and principle of this application shall fall within the protection scope of this application.

1. A redirection method, wherein the method is applied to a narrowband internet of things, and the method comprises:
sending, by a terminal device, a radio resource control (RRC) connection request message to a network device, wherein the RRC connection request message is used to request to establish an RRC connection in a first cell;
receiving, by the terminal device, an RRC connection reject message sent by the network device, wherein the RRC connection reject message includes redirection information; and
choosing, by the terminal device based on the redirection information, to camp on a second cell.

2. The method according to claim 1, wherein the redirection information comprises a plurality of carrier frequencies, and the choosing, by the terminal device based on the redirection information, to camp on a second cell comprises:
searching, by the terminal device, the plurality of carrier frequencies, and choosing to camp on the second cell corresponding to a target carrier frequency in the plurality of carrier frequencies.

3. The method according to claim 2, wherein the searching, by the terminal device, the plurality of carrier frequencies, and choosing to camp on the second cell corresponding to a target carrier frequency in the plurality of carrier frequencies comprises:
obtaining, by the terminal device, reference signal received power (RSRP) corresponding to each of the plurality of carrier frequencies; and
choosing, by the terminal device based on the RSRP, to camp on the second cell corresponding to the target carrier frequency in the plurality of carrier frequencies.

4. The method according to claim 3, wherein the redirection information comprises a redirection carrier dedicated offset, and the redirection carrier dedicated offset is added to RSRP of one of the plurality of carrier frequencies to reduce a probability that a cell corresponding to the carrier frequency is chosen.

5. The method according to claim 1, wherein the redirection information comprises extended waiting time, and the extended waiting time indicates waiting duration in which the terminal device searches the first cell again to establish the RRC connection.

6. A terminal device, comprising:
at least one processor; and
a memory coupled to the at least one processor, the memory comprising instructions that, when executed by the at least one processor, cause the terminal device to:
send a radio resource control (RRC) connection request message to a network device, wherein the RRC connection request message is used to request to establish an RRC connection in a first cell;
receive an RRC connection reject message sent by the network device, wherein the RRC connection reject message includes redirection information; and
choose, based on the redirection information, to camp on a second cell.

7. The terminal device according to claim 6, wherein the redirection information comprises a plurality of carrier frequencies; and
the instructions, when executed by the at least one processor, cause the terminal device to search the plurality of carrier frequencies, and choose to camp on the second cell corresponding to a target carrier frequency in the plurality of carrier frequencies.

8. The terminal device according to claim 7, wherein the instructions, when executed by the at least one processor, cause the terminal device to obtain reference signal received power (RSRP) corresponding to each of the plurality of carrier frequencies, and choose, based on the RSRP, to camp on the second cell corresponding to the target carrier frequency in the plurality of carrier frequencies.

9. The terminal device according to claim 8, wherein the redirection information comprises a redirection carrier dedicated offset, and the redirection carrier dedicated offset is added to RSRP of one of the plurality of carrier frequencies to reduce a probability that a cell corresponding to the carrier frequency is chosen.

10. The terminal device according to claim 6, wherein the redirection information comprises extended waiting time, and the extended waiting time indicates waiting duration in which the terminal device searches the first cell again to establish the RRC connection.

11. A network device, comprising:
at least one processor; and
a memory coupled to the at least one processor, the memory comprising instructions that, when executed by the at least one processor, cause the network device to:
receive a radio resource control (RRC) connection request message sent by a terminal device, wherein the RRC connection request message is used to request to establish an RRC connection in a first cell; and
send an RRC connection reject message to the terminal device, wherein the RRC connection reject message includes redirection information, and the redirection information indicates the terminal device to choose to camp on a second cell.

12. The network device according to claim 11, wherein the redirection information comprises a plurality of carrier frequencies, and the plurality of carrier frequencies are used by the terminal device to perform searching and choose to camp on the second cell corresponding to a target carrier frequency.

13. The network device according to claim 12, wherein the redirection information comprises a redirection carrier dedicated offset, and the redirection carrier dedicated offset is added to reference signal received power (RSRP) of one of the plurality of carrier frequencies to reduce a probability that a cell corresponding to the carrier frequency is chosen.

14. The network device according to claim 11, wherein the redirection information comprises extended waiting time, and the extended waiting time indicates waiting duration in which the terminal device searches the first cell again to establish an RRC connection.

15. The network device according to claim 11, wherein the instructions, when executed by the at least one processor, cause the network device to:
when load of the first cell exceeds a first preset threshold or load of a core network in which the first cell is located exceeds a second preset threshold, send the RRC connection reject message to the terminal device.
